(19) United States
(12) Patent Application Publication
(10) Pub. No.: US 2020/0408709 A1
(43) Pub. Date: Dec. 31, 2020

(54) HUMIDITY DETECTOR AND IMAGE FORMING APPARATUS

(71) Applicant: Oki Data Corporation, Tokyo (JP)

(72) Inventor: Shuichi FUJIKURA, Tokyo (JP)

(21) Appl. No.: 16/906,731

(22) Filed: Jun. 19, 2020

(30) Foreign Application Priority Data
Jun. 27, 2019 (JP) 2019-119499

(51) Int. Cl. G01N 27/22; G01N 27/60

(52) U.S. Cl. CPC G01N 27/223; G01N 27/605

(57) ABSTRACT

A humidity detector includes a humidity sensor; a voltage dividing resistance that converts a current analog signal of the humidity sensor to a voltage analog signal indicating a voltage value corresponding to a resistance value of the humidity sensor; a switcher that alternately applies first voltage and second voltage to the humidity sensor, the first voltage causing current to flow in a first direction, the second voltage causing current to flow in a second direction different from the first direction through the voltage dividing resistance; and an ASIC having a first detection mode for determining humidity in accordance with a first voltage value detected while the first voltage is being applied and a second detection mode for determining humidity in accordance with a second voltage value detected while the second voltage is being applied.

### CROSS-REFERENCE TO RELATED APPLICATIONS

This application claims priority under 35 U.S.C. § 119(b) to Japanese Patent Application No. 2019-119499, filed Jun. 27, 2019, the disclosure of which is incorporated herein by reference in its entirety.

### BACKGROUND OF THE INVENTION

### 1. Field of the Invention

The present invention relates to a humidity detector and an image forming apparatus.

### 2. Description of the Related Art

Electrophotographic printers should accurately detect humidity because the behavior of toner changes significantly under low temperature and low humidity.

There is a well-known conventional device that converts current, which varies in accordance with humidity and is output from a humidity sensor, to corresponding voltage with a current-to-voltage converter circuit including a voltage follower, and converts the converted voltage to a digital value with an A/D converter as a digital converter circuit, to detect humidity (for example, refer to Japanese Patent Application Publication No. 2010-243235).

### SUMMARY OF THE INVENTION

However, it is difficult for a well-known conventional device to detect humidity accurately under wide-humidity-range environments from high humidity to low humidity.

Accordingly, an object of at least one aspect of the present invention is to achieve accurate detection of humidity even under wide-humidity-range environments.

A humidity detector according to an aspect of the present invention includes a humidity sensor that has a resistance value varying in accordance with humidity; a resistor that is used for converting a current analog signal to a voltage analog signal, the current analog signal corresponding to a current value of current flowing through the humidity sensor, the voltage analog signal indicating a voltage value corresponding to the resistance value; an alternating voltage supply unit that alternately applies first voltage and second voltage to the humidity sensor, the first voltage causing current to flow in a first direction, the second voltage causing current to flow in a second direction through the resistor, the second direction being a direction different from the first direction; and a control circuit that has a first detection mode and a second detection mode, the first detection mode being a mode for determining the humidity detected by the humidity sensor in accordance with a first voltage value detected by using a digital signal corresponding to the voltage analog signal while the first voltage is being applied to the humidity sensor, the second detection mode being a mode for determining the humidity detected by the humidity sensor in accordance with a second voltage value detected by using a digital signal corresponding to the voltage analog signal while the second voltage is being applied to the humidity sensor.

According to at least one aspect of the present invention, humidity can be accurately detected.

### BRIEF DESCRIPTION OF THE DRAWINGS

In the attached drawings:

FIG. 1 is a longitudinal cross-sectional diagram schematically illustrating the configuration of an image forming apparatus according to an embodiment.

FIG. 2 is a block diagram schematically illustrating the configuration of a control system of an image forming apparatus.

FIG. 3 is a circuit diagram illustrating an example circuitry of sections that detect humidity in an environment sensor substrate and a main substrate.

FIG. 4 is a schematic chart of relations between resistance values of a resistance change type humidity sensor and humidity.

FIGS. 5A to 5C are schematic charts of voltage waveforms of signals input to an A/D converter.

FIG. 6 is a schematic chart for explaining the timings of detecting voltage.

FIG. 7 is a flowchart illustrating an operation for determining detection timings of humidity.

FIG. 8 is a flowchart illustrating a first operation performed when an ASIC outputs a falling edge of a PWM signal.

FIG. 9 is a flowchart illustrating a first operation performed when set time passes.

FIG. 10 is a flowchart illustrating a second operation performed when an ASIC outputs a falling edge of a PWM signal.

FIG. 11 is a flowchart illustrating a second operation performed when set time passes.

FIG. 12 is a flowchart illustrating a third operation performed when set time passes.

### DETAILED DESCRIPTION OF THE INVENTION

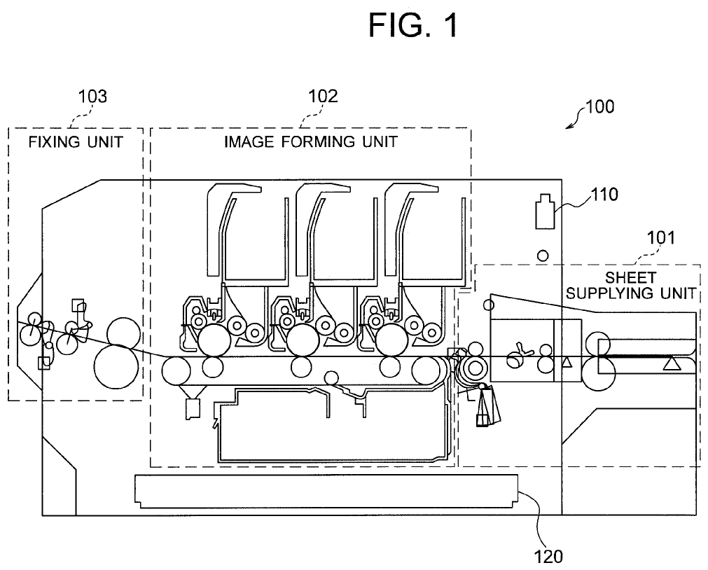

FIG. 1 is a longitudinal cross-sectional diagram schematically illustrating the configuration of an image forming apparatus 100 according to an embodiment.

The image forming apparatus 100 includes a sheet supplying unit 101, an image forming unit 102, a fixing unit 103, an environment sensor substrate 110, and a main substrate 120.

The sheet supplying unit 101 is a medium supplying unit that supplies a sheet of paper, which is a medium on which an image is formed.

The image forming unit 102 performs an electrophotographic process by using a toner as a developer to form a toner image, which is a developer image, on a sheet.

The fixing unit 103 fixes the toner image formed on the sheet onto the sheet.

The environment sensor substrate 110 measures temperature and humidity.

The main substrate 120 controls the sheet supplying unit 101, the image forming unit 102, and the fixing unit 103 in accordance with the temperature and humidity measured by the environment sensor substrate 110.

Specifically, the developing process and the transfer process of the electrophotographic process are significantly affected by the absolute humidity because these processes handle powder. Therefore, the main substrate 120 needs temperature and humidity measured by the environment sensor substrate 110 in order to calculate the correction for the development bias and the transfer bias.

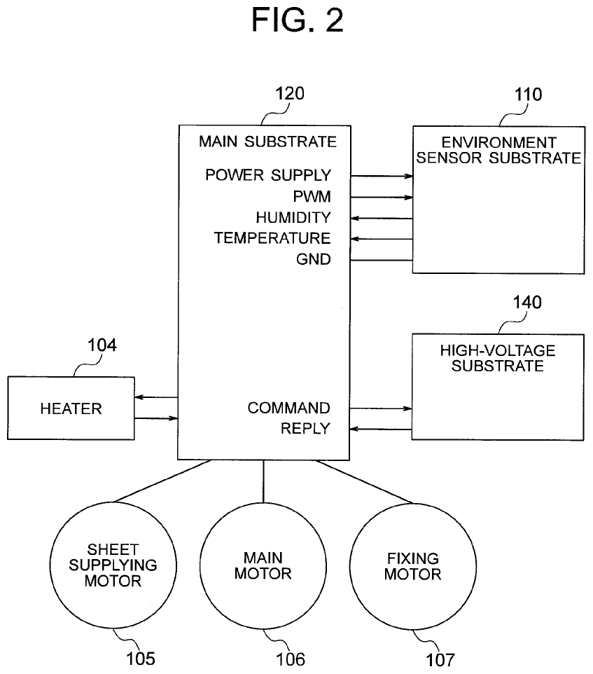

FIG. 2 is a block diagram schematically illustrating the configuration of a control system of an image forming apparatus 100.

The control system of the image forming apparatus 100 includes the environment sensor substrate 110, the main substrate 120, and a high-voltage substrate 140.

The main substrate 120 supplies power and a pulse width modulation (PWM) signal, which is an alternating signal or a switch signal, to the environment sensor substrate 110.

The main substrate 120 then receives, from the environment sensor substrate 110, an analog signal having voltage indicating the humidity and an analog signal having voltage indicating the temperature.

The main substrate 120 determines the humidity and the temperature from the voltage from the environment sensor substrate 110. When the humidity is low according to the determined humidity and the determined temperature, the main substrate 120 outputs commands to the high-voltage substrate 140 to correct the development bias and the transfer bias so that the development bias may decrease and the transfer bias may increase.

The main substrate 120 then receives a reply to the command from the high-voltage substrate 140.

The main substrate 120 is coupled to a heater 104 used in the fixing unit 103, a sheet supplying motor 105 used in the sheet supplying unit 101, a main motor 106 used in the image forming unit 102, and a fixing motor 107 that drives a fixing device of the fixing unit 103. The main substrate 120 controls these components.

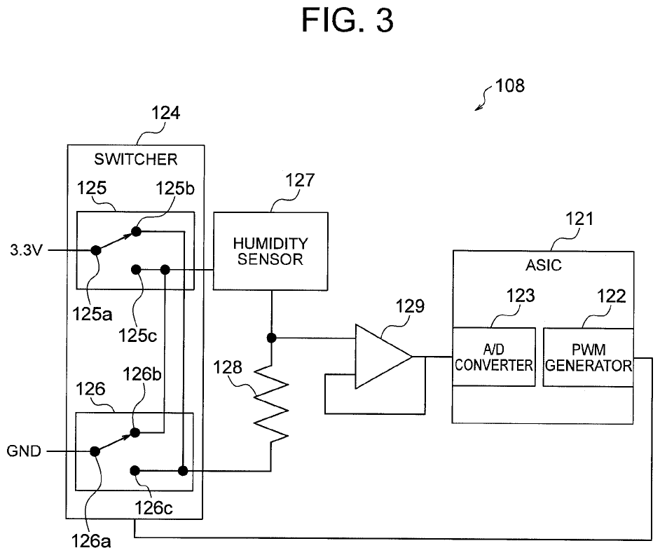

FIG. 3 is a circuit diagram illustrating an example circuitry of a humidity detector 108 that is a section detecting humidity in the environment sensor substrate 110 and a section of the main substrate 120.

An application-specific integrated circuit (ASIC) 121 provided on the main substrate 120 as a controller includes a PWM generator 122 as a PWM generating unit or a switch signal generator, and an analog-to-digital (A/D) converter 123 as an analog signal/digital signal converting unit. The switch signal generator generates a switch signal at a predetermined period.

The PWM generator 122 generates a PWM signal for instructing switching of alternating voltage to be supplied to a humidity sensor 127, and supplies the generated PWM signal to the environment sensor substrate 110. The PWM signal in this embodiment has, for example, a cycle of 1 kHz and a duty cycle of 50%. In other words, the PWM signal is a pulsed signal alternating between an on-state and an off-states.

The A/D converter 123 receives input of a transformed analog signal, which is an analog signal indicating a voltage value corresponding to the humidity detected by the environment sensor substrate 110, and converts the transformed analog signal to a digital signal indicating the voltage value. Here, it is presumed that the output impedance requested by the A/D converter 123 is 250Ω or less. It is also presumed that the humidity detected by the environment sensor substrate 110 corresponds to the resistance value of the humidity sensor 127.

The environment sensor substrate 110 further includes a switcher 124, the humidity sensor 127, a voltage dividing resistance 128, and a voltage follower 129.

The switcher 124 is a switching circuit including a first switch 125 and a second switch 126.

The first switch 125 includes a common terminal 125a that receives 3.3-V input from the main substrate 120, a first connection terminal 125b, and a second connection terminal 125c.

The first switch 125 can switch the connection destination of the common terminal 125a between the first connection terminal 125b and the second connection terminal 125c in accordance with the PWM signal supplied from the ASIC 121.

The second switch 126 includes a common terminal 126a coupled to a GND terminal of the main substrate 120, a first connection terminal 126b, and a second connection terminal 126c.

The second switch 126 can switch the connection destination of the common terminal 126a between the first connection terminal 126b and the second connection terminal 126c in accordance with the PWM signal supplied from the ASIC 121.

For example, when the PWM signal is in an on-state, the common terminal 125a of the first switch 125 is coupled to the first connection terminal 125b, and the common terminal 126a of the second switch 126 is coupled to the first connection terminal 126b. In this way, the 3.3-V input supplied from the main substrate 120 enters the first connection terminal 125b of the first switch 125, passes through the voltage dividing resistance 128, and is supplied to the humidity sensor 127. In such a case, negative voltage is applied to the humidity sensor 127.

In contrast, when the PWM signal is in an off-state, the common terminal 125a of the first switch 125 is coupled to the second connection terminal 125c, and the common terminal 126a of the second switch 126 is coupled to the second connection terminal 126c. In this way, the 3.3-V input supplied from the main substrate 120 enters the second connection terminal 125c of the first switch 125 and is supplied to the humidity sensor 127. In such a case, positive voltage is applied to the humidity sensor 127.

As described above, the humidity sensor 127 receives alternating voltage from the switcher 124. In other words, the switcher 124 functions as an alternating voltage supply unit that alternately applies first voltage and second voltage to the humidity sensor 127. The first voltage causes current to flow in a first direction (a direction from the humidity sensor 127 to the voltage dividing resistance 128 in FIG. 3). The second voltage causes current to flow in a second direction different from the first direction (a direction from the voltage dividing resistance 128 to the humidity sensor 127 in FIG. 3). Here, in this embodiment, the second direction is the opposite direction to the first direction. The first voltage is a first polarity and the second voltage is a second polarity which is a reverse polarity of the first voltage.

The humidity sensor 127 is a resistance change type humidity sensor in which the resistance value varies in accordance with humidity. Here, a resistive-type polymeric-membrane humidity sensor is used as the humidity sensor 127. Specifically, “CHS-KSS-CA1” available from TDK Corporation is used as the humidity sensor 127.

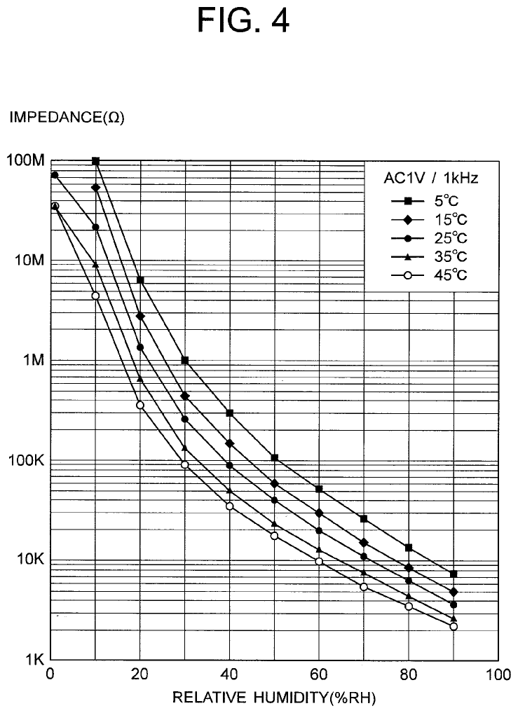

In general, the relations between humidity and the resistance values of a resistance change type humidity sensor using an element that has a resistance value varying in accordance with the humidity is as illustrated in FIG. 4.

As illustrated in FIG. 4, the resistance values of the resistance change type humidity sensor are small values under a high-temperature, high-humidity environment. Under a low-temperature, low-humidity environment, the resistance values are significantly large values. The resistance values increase by four or five digits.

Alternating voltage is applied to the resistance change type humidity sensor to avoid electrolysis (polarization) at the humidity sensor element. Also, in this embodiment, alternating voltage is applied to the humidity sensor 127 by the switcher 124.

The voltage dividing resistance 128 is provided to convert a current value corresponding to the resistance value of the humidity sensor 127 to a voltage value.

Specifically, the voltage dividing resistance 128 is a resistor that converts a current analog signal corresponding to the current value of the current flowing through the humidity sensor 127 to a voltage analog signal having a voltage value corresponding to the resistance value of the humidity sensor 127.

Here, it is presumed that the resistance value of the voltage dividing resistance 128 is 62 kΩ, which is the same value as the resistance value of the humidity sensor 127 at a temperature of 15° C. and a humidity of 50%.

The voltage follower 129 performs impedance transformation for impedance matching with the required output impedance of the A/D converter 123 of the ASIC 121.

Specifically, the voltage follower 129 performs impedance transformation of the voltage analog signal converted by the voltage dividing resistance 128, to generate a transformed analog signal. The transformed analog signal is supplied to the ASIC 121.

In the configuration described above, the ASIC 121 is a control circuit that detects a voltage value by converting the transformed analog signal generated by the voltage follower 129 to a digital signal, and determines the humidity detected by the humidity sensor 127 in accordance with the detected voltage value.

Specifically, the ASIC 121 has a first detection mode and a second detection mode. In the first detection mode, the ASIC 121 determines the humidity detected by the humidity sensor 127 in accordance with the first voltage value detected while the first voltage, which is positive voltage, is being applied to the humidity sensor 127. In the second detection mode, the ASIC 121 determines the humidity detected by the humidity sensor 127 in accordance with the second voltage value detected while the second voltage, which is negative voltage, is being applied to the humidity sensor 127.

In other words, each of the first voltage value and the second voltage value is detected by using a digital signal corresponding to the voltage analog signal converted converted by the voltage dividing resistance 128.

When the first voltage value is larger than or equal to a predetermined threshold value, the ASIC 121 uses the first detection mode, whereas, when the first voltage value is smaller than the predetermined threshold value, the ASIC 121 uses the second detection mode.

Note that the threshold value may be a lower limit of the voltage guaranteed by the operational amplifier used as the voltage follower 129 or a sum of the lower limit and a predetermined margin so that the threshold value is larger than the lower limit. In other words, the threshold value may be larger than or equal to the lower limit.

In the second detection mode, the current flowing through the voltage dividing resistance 128 is divided between the humidity sensor 127 and the voltage follower 129. Since the resistance value of the voltage dividing resistance 128 is a constant value, even when the resistance value of the humidity sensor 127 significantly increases under a low-humidity, low-temperature environment, only the current value of the current flowing to the humidity sensor 127 significantly decreases. Therefore, the voltage follower 129 receives current corresponding to voltage larger than or equal to the lower limit of the voltage guaranteed by the operational amplifier.

The operation of the image forming apparatus 100 will now be explained.

The image forming apparatus 100 starts printing (image formation) in response to an instruction from a host computer (not illustrated).

The main substrate 120 reads output (temperature and humidity, in this case) from the environment sensor substrate 110 to correct the development bias and the transfer bias before the start of the print.

After the development bias and the transfer bias have been determined, the main substrate 120 heats the heater 104 provided in the fixing unit 103.

When the temperature of the heater 104 reaches a fixing target temperature, the main substrate 120 turns on the sheet supplying motor 105 and starts supplying a sheet to the sheet supplying unit 101.

When the sheet supplying starts, the main substrate 120 operates the image forming unit 102 and starts exposure at the point where the sheet reaches a sheet supplying sensor (not illustrated).

An electrostatic latent image formed on a photosensitive drum by the exposure is developed into a toner image. The toner image is transferred to the sheet through the transfer process.

The transferred toner image is transported to the fixing unit 103 together with the transported sheet. At the fixing unit 103, the toner image is fixed to the sheet by heat of approximately 170° C. and pressure.

The sheet to which the toner image is fixed is farther transported and ejected to the outside of the image forming apparatus 100.

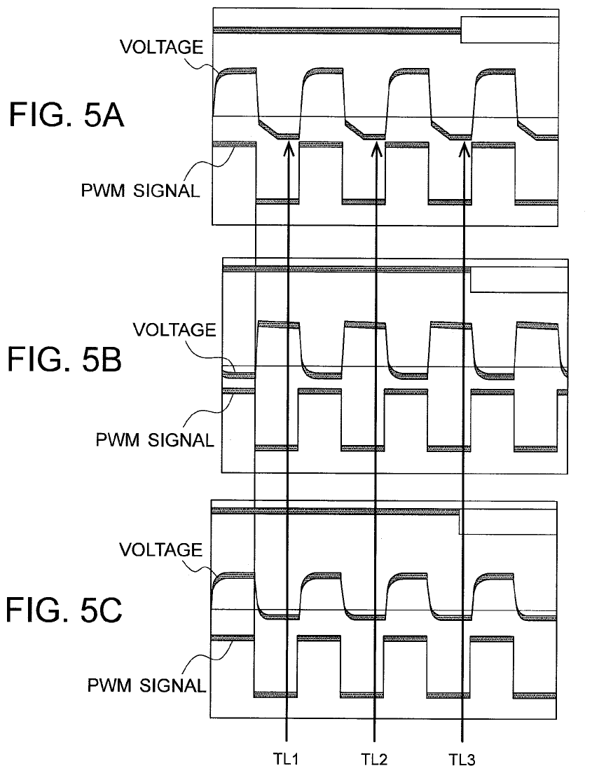

FIGS. 5A to 5C are schematic charts of the voltage waveforms of signals input to the A/D converter 123 in the circuit illustrated in FIG. 3.

FIG. 5A illustrates a waveform under low temperature and low humidity. FIG. 5B illustrates a waveform under a laboratory environment. FIG. 5C illustrates a waveform under high temperature and high humidity.

Each of FIGS. 5A to 5C illustrates, in the lower section, the waveform of the PWM signal output from the PWM generator 122, and, in the upper section, the waveform of the voltage input to the A/D converter 123.

Alternating voltage is applied to the humidity sensor 127 for prevention of ionic polarization. Therefore, the humidity sensor 127 alternately outputs high voltage and low voltage. The waveform of the voltage more or less evens out at 10° C. and a relative humidity (RH) of 50%. The waveform is inverted before and after the evening out. Since the voltage is unstable immediately after the inversion of the voltage, the voltage is sampled after the voltage stabilizes. As in the embodiment described above, the alternating voltage is switched by a PWM signal. The cycle of the PWM signal is 1 kHz, and the duty cycle is 50%.

Conventionally, the voltage has been sampled at first timings TL1 to TL3 at which the PWM signal is in an off-state, as illustrated in FIG. 5. Each of the first timings TL1 to TL3 corresponds to a point when predetermined time, for example, 350 μs is passed after the falling edges of the PWM signal.

For example, in the case where the “CHS-KSS-CA1” is used as the humidity sensor 127, as described above, the resistance is 2.5 kΩ under an environment of 35° C. and 90% RH, and the resistance is 75 MΩ under an environment of 5° C. and 10% RH. That is, the range of the resistance is significantly large.

In the case where a 62-kΩ resistor having the same resistance value as that of the humidity sensor 127 under an environment of 15° C. and 50% RH is used as the voltage dividing resistance 128 in a circuit for converting a resistance value to a voltage value by using the voltage dividing resistance 128, as illustrated in FIG. 3, the voltage input under an environment of 5° C. and 10% RH to the A/D converter 123 is 49 mV, which is significantly low voltage.

As described above, the output impedance requested by the A/D converter 123 is 250Ω or less, which is lower than the resistance value of the humidity sensor 127. Therefore, an operational amplifier should be used as the voltage follower 129 to perform the impedance transformation.

In the case where, for example, an LMV324, which is a general-purpose operational amplifier, is used as the operational amplifier, output of 65 mV or less is not guaranteed. Therefore, when the voltage follower 129 attempts to output voltage smaller than 65 mV, the output voltage will not be smaller than 65 mV. Therefore, even if the humidity sensor 127 in the circuit illustrated in FIG. 3 outputs voltage of 49 mV corresponding to a humidity of 10% RH at 15° C., the voltage follower 129 can only output voltage of 65 mV, which indicates 14% RH. Therefore, the A/D converter 123 will convert the voltage to a humidity value different from the humidity value detected at the humidity sensor 127, and the ASIC 121 will recognize a humidity value different from the actual humidity.

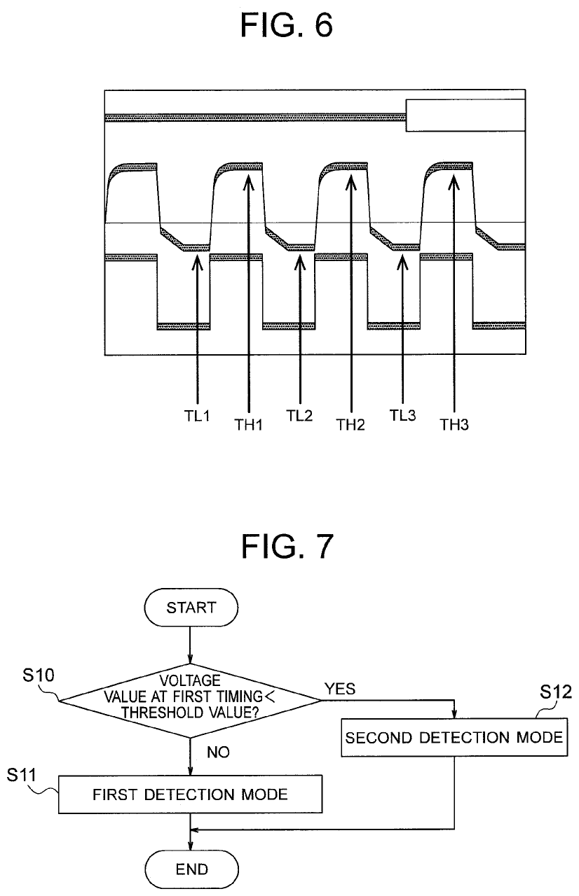

Therefore, in this embodiment, the voltage is also able to be sampled at second timings TH1 to TH3 at which the PWM signal output from the PWM generator 122 is in an on-state, in addition to the first timings TL1 to TL3 at which the PWM signal is in an off-state, as illustrated in FIG. 6. In this way, the ASIC 121 is able to select one of the voltage value detected at the first timing and the voltage value detected at the second timing to use.

In this embodiment, when the voltage value detected at the first timing is smaller than switching voltage, which is a predetermined threshold value, the ASIC 121 detects the voltage value at the second timing.

The ASIC 121 preliminarily stores a first table and a second table. The first table represents first humidity information about the humidity values corresponding to the voltage values detected at the first timings. The second table represents second humidity information about the humidity values corresponding to the voltage values detected at the second timings.

Therefore, in this embodiment, the voltage from the humidity sensor 127 does not shift at the voltage follower 129 under a low-temperature, low-humidity environment.

FIG. 7 is a flowchart illustrating an operation of the ASIC 121 for determining the detection timings of humidity.

The flowchart illustrated in FIG. 7 is started when a voltage value is detected at a first timing corresponding to a point when predetermined time (350 μs in this case) is passed after a falling edge of a PWM signal.

The ASIC 121 determines whether or not the voltage value detected at the first timing is smaller than the switching voltage, which is a predetermined threshold value (step S10). In the case where the general-purpose operational amplifier LMV324 is used as the voltage follower 129, as described above, the voltage becomes constant at 65 mV, which is the lower limit of the voltage guaranteed by the operational amplifier, although this may differ depending on the specification of the operational amplifier to be used. Therefore, the switching voltage is set at 100 mV, which is determined by adding a predetermined margin to the lower limit of the voltage.

If the voltage value detected at the first timing is larger than or equal to the predetermined threshold value (NO in step S10), the process proceeds to step S11. If the voltage value detected at the first timing is smaller than the predetermined threshold value (YES in step S10), the process proceeds to step S12.

In step S11, the ASIC 121 performs a process in the first detection mode to determine the humidity from the voltage value detected at the first timing.

In step S12, the ASIC 121 performs a process in the second detection mode to determine the humidity from the voltage value detected at a second timing.

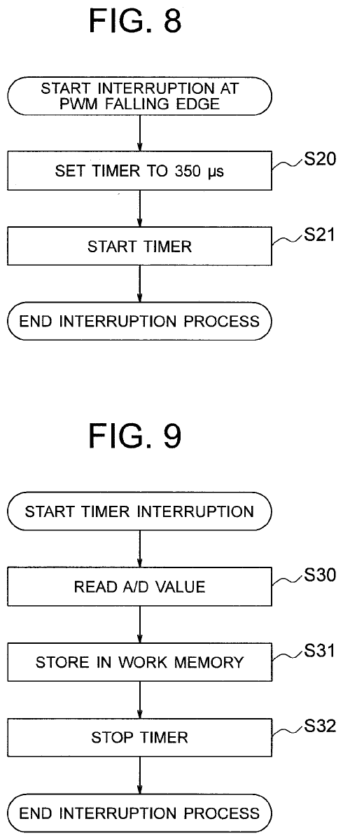

The overall operation of the ASIC 121 for detecting the humidity in the first detection mode will now be described with reference to FIGS. 8 and 9.

FIG. 8 is a flowchart illustrating the operation performed when the ASIC 121 outputs a falling edge of a PWM signal.

The flowchart illustrated in FIG. 8 is started when the PWM generator 122 outputs the falling edge of the PWM signal.

The ASIC 121 sets counting time of 350 μs to a timer (step S20).

The ASIC 121 then starts counting the set time with the timer (step S21).

FIG. 9 is a flowchart illustrating the operation performed at the time set in FIG. 8.

If the time set in step S20 in FIG. 8 is passed, the ASIC 121 reads the voltage value, which is the A/D value converted by the A/D converter 123, from the A/D converter 123 (step S30).

The ASIC 121 then stores the read voltage value in a work memory (not illustrated) (step S31). The ASIC 121 uses the voltage value stored in the work memory to execute the flowchart illustrated in FIG. 7. In this case, the ASIC 121 is operating in the first detection mode, and uses the first table to determine the humidity on the basis of the voltage value read at a first timing, i.e., in step S30, and stored in step S31.

The ASIC 121 then stops counting the set time with the timer (step S32).

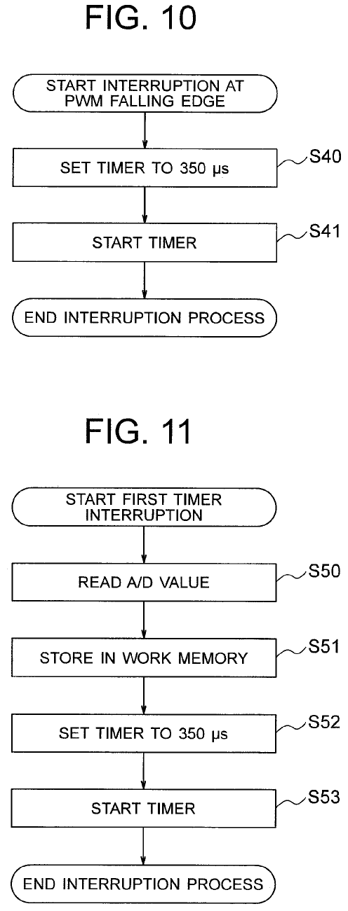

The overall operation of the ASIC 121 for detecting humidity in the second detection mode will now be described with reference to FIGS. 10 to 12.

FIG. 10 is a flowchart illustrating the operation performed when the ASIC 121 outputs a falling edge of a PWM signal.

The flowchart illustrated in FIG. 10 is started when the PWM generator 122 outputs the falling edge of the PWM signal.

The ASIC 121 sets counting time of 350 μs to a timer (step S40).

The ASIC 121 then starts counting the set time with the timer (step S41).

FIG. 11 is a flowchart illustrating the operation performed at the time set in FIG. 10.

If the time set in step S40 in FIG. 10 is passed, the ASIC 121 reads the voltage value, which is the A/D value converted by the A/D converter 123, from the A/D converter 123 (step S50).

The ASIC 121 then stores the read voltage value in a work memory (not illustrated) (step S51). The ASIC 121 uses the voltage value stored in the work memory to execute the flowchart illustrated in FIG. 7. In this case, the ASIC 121 enters the second detection mode, and the process proceeds to step S52.

In step S52, the ASIC 121 sets counting time of 500 μs to the timer.

The ASIC 121 then starts counting the set time with the timer (step S53).

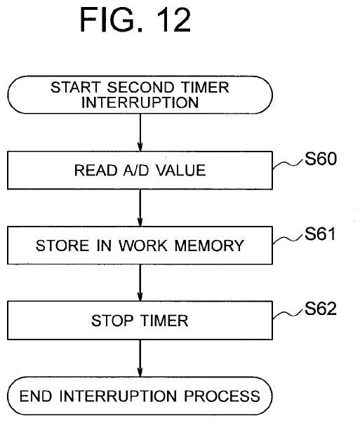

FIG. 12 is a flowchart illustrating an operation performed when the time set in FIG. 11 is passed.

If the time set in step S52 in FIG. 11 is passed, the ASIC 121 reads the voltage value, which is the A/D value converted by the A/D converter 123, from the A/D converter 123 (step S60).

The ASIC 121 then stores the read voltage value in a work memory (not illustrated) (step S61). In this case, the ASIC 121 is operating in the second detection mode, and uses the second table to determine the humidity on the basis of the voltage value read in step S60 and stored in step S61.

The ASIC 121 then stops counting the set time with the timer (step S62).

According to the embodiment described above, it is possible to prevent inaccurate detection of a humidity value at low humidity due to the output being fixed at a low humidity value. This enables accurate detection of low humidity.

In an electrophotographic printer, the behavior of toner changes significantly under low temperature and low humidity. Therefore, by accurately detecting a humidity value under low humidity and controlling the development bias and the transfer bias, the behavior of the toner can be stably controlled, and thereby, a decrease in image quality can be prevented.

In the example described above, the image forming apparatus 100 is applied to an electrophotographic printer. However, the embodiment is not limited to such an example. For example, the embodiment may be applied to an inkjet printer. Inkjet printers have some problems such as a problem in that colors are unstable under low humidity. Therefore, accurate detection of the humidity under low humidity contributes to the stabilization of color.

Note that the embodiment described above may be applied to multi-purpose peripherals and facsimile machines besides printers.

1. A humidity detector comprising:
a humidity sensor that has a resistance value varying in accordance with humidity;
a resistor that is used for converting a current analog signal to a voltage analog signal, the current analog signal corresponding to a current value of current flowing through the humidity sensor, the voltage analog signal indicating a voltage value corresponding to the resistance value;
an alternating voltage supply unit that alternately applies first voltage and second voltage to the humidity sensor, the first voltage causing current to flow in a first direction, the second voltage causing current to flow in a second direction through the resistor, the second direction being a direction different from the first direction; and
a control circuit that has a first detection mode and a second detection mode, the first detection mode being a mode for determining the humidity detected by the humidity sensor in accordance with a first voltage value detected by using a digital signal corresponding to the voltage analog signal while the first voltage is being applied to the humidity sensor, the second detection mode being a mode for determining the humidity detected by the humidity sensor in accordance with a second voltage value detected by using a digital signal corresponding to the voltage analog signal while the second voltage is being applied to the humidity sensor.

2. The humidity detector according to claim 1, wherein,
the control circuit uses the first detection mode when the first voltage value is larger than or equal to a predetermined threshold value, and
the control circuit uses the second detection mode when the first voltage value is smaller than the predetermined threshold value.

3. The humidity detector according to claim 2, further comprising a voltage follower that generates a transformed analog signal by performing impedance transformation of the voltage analog signal, wherein
each of the first voltage value and the second voltage value is detected by converting the transformed analog signal to the digital signal, and
the threshold value is a lower limit of a voltage value guaranteed by an operational amplifier used as the voltage follower or a sum of the lower limit and a predetermined margin, the sum being larger than the lower limit.

4. The humidity detector according to claim 1, wherein,
in the first detection mode, the control circuit uses first humidity information indicating a humidity value corresponding to the first voltage value, to determine the humidity detected by the humidity sensor in accordance with the first voltage value, and
in the second detection mode, the control circuit uses second humidity information indicating a humidity value corresponding to the second voltage value, to determine the humidity detected by the humidity sensor in accordance with the second voltage value.

5. The humidity detector according to claim 1, wherein,
the control circuit outputs a pulsed signal alternately indicating an on-state and an off-state to the alternating voltage supply unit, and
the alternating voltage supply unit switches between the first voltage and the second voltage in accordance with the on-state and the off-state.

6. The humidity detector according to claim 1, wherein,
the first voltage is a first polarity, and
the second voltage is a second polarity which is a reverse polarity of the first voltage.

7. The humidity detector according to claim 1, wherein,
the control circuit outputs a switch signal to the alternating voltage supply unit, and
the alternating voltage supply unit alternately applies the first voltage and the second voltage in accordance with the switch signal.

8. The humidity detector according to claim 7, wherein,
the control circuit includes a switch signal generator that generate the switch signal, and
the switch signal generator generate the switch signal at a predetermined period.

9. An image forming apparatus comprising a humidity detector, wherein
the humidity detector includes:
a humidity sensor that has a resistance value varying in accordance with humidity;
a resistor that is used for converting a current analog signal to a voltage analog signal, the current analog signal corresponding to a current value of current flowing through the humidity sensor, the voltage analog signal indicating a voltage value corresponding to the resistance value;
an alternating voltage supply unit that alternately applies first voltage and second voltage to the humidity sensor, the first voltage causing current to flow in a first direction, the second voltage causing current to flow in a second direction through the resistor, the second direction being a direction different from the first direction; and
a control circuit that has a first detection mode and a second detection mode, the first detection mode being a mode for determining the humidity detected by the humidity sensor in accordance with a first voltage value detected by using a digital signal corresponding to the voltage analog signal while the first voltage is being applied to the humidity sensor, the second detection mode being a mode for determining the humidity detected by the humidity sensor in accordance with a second voltage value detected by using a digital signal corresponding to the voltage analog signal while the second voltage is being applied to the humidity sensor.
